(19) United States
(12) Patent Application Publication
(10) Pub. No.: US 2019/0249789 A1
(43) Pub. Date: Aug. 15, 2019

(54) ELECTRICAL VALVE MODULE ASSEMBLY FOR INFLATION SYSTEMS

(71) Applicant: Goodrich Corporation, Charlotte, NC (US)

(72) Inventors: Poly Puthur John, Bangalore (IN); Priyank Anavadiya, Bangalore (IN)

(21) Appl. No.: 15/956,935

(22) Filed: Apr. 19, 2018

(30) Foreign Application Priority Data
Feb. 15, 2018 (IN) 201811005752

(51) Int. Cl. F16K 11/07; F16K 15/20; G05D 16/20

(52) U.S. Cl. CPC F16K 11/0712; G05D 16/2013; F16K 15/20

(57) ABSTRACT

Embodiments of the invention include an inflation system and valve having a fluid source, a valve housing, wherein the valve housing includes an inlet, an outlet and a leak vent, wherein the fluid source is coupled to the inlet, a first cavity, a second cavity, and outlet cavity, wherein a pilot feed line couples the first cavity to the second cavity, a valve spool positioned within the valve housing, wherein the valve spool includes one or more seals, and a solenoid for controlling fluid flow between the first cavity and the second cavity.

### CROSS-REFERENCE TO RELATED APPLICATIONS

This application claims the benefit of Indian Application No. 201811005752 filed Feb. 15, 2018, which is incorporated herein by reference in its entirety.

### BACKGROUND

The present invention generally relates to valves, and more specifically, to an electrical valve module assembly for inflation systems.

Inflation systems are used for a variety of applications including both personal and commercial uses. For example, personal applications can include inflating a bicycle tire or floatation device. Commercial uses can include emergency equipment for aircrafts and automobiles. Inflation systems use high pressure stored gas, which needs to be discharged within specified time by opening a normally closed inflation valve. The rate and period at which the gas is released can be based on the application. In addition, the mechanisms of the inflation valves and devices can vary from one application to the next. For example, pneumatic inflation valves can be actuated by mechanical or electrical means. Conventional pneumatic inflation valves are configured using poppets having radial seals and are designed for single opening actuation.

### BRIEF DESCRIPTION

According to one embodiment, an inflation system includes a fluid source, a valve housing, wherein the valve housing includes an inlet, an outlet and a leak vent, wherein the fluid source is coupled to the inlet, a first cavity, a second cavity, and outlet cavity, wherein a pilot feed line couples the first cavity to the second cavity, a valve spool positioned within the valve housing, wherein the valve spool includes one or more seals, and a solenoid for controlling fluid flow between the first cavity and the second cavity.

In addition to one or more of the features described above, or as an alternative, further embodiments may include wherein the solenoid receives inlet pressure from the first cavity and provides outlet pressure to the second cavity.

In addition to one or more of the features described above, or as an alternative, further embodiments may include wherein the pilot feed line is embedded within the valve housing.

In addition to one or more of the features described above, or as an alternative, further embodiments may include wherein the first cavity includes a first end cap and the second cavity includes a second end cap, wherein the first end cap and the second end cap include O-ring seals.

In addition to one or more of the features described above, or as an alternative, further embodiments may include wherein the second end cap includes a mechanical stopper for contacting the spool and a plug for removing fluid pressure.

In addition to one or more of the features described above, or as an alternative, further embodiments may include wherein a guide face of the valve spool in the second cavity is larger than a guide face of the valve spool in the first cavity.

In addition to one or more of the features described above, or as an alternative, further embodiments may include wherein the valve spool is positioned in a closed position, the valve spool fluidly decouples the inlet from the outlet.

In addition to one or more of the features described above, or as an alternative, further embodiments may include wherein the valve spool is positioned in an open position, the valve spool fluidly couples the inlet to the outlet and blocks the leak vent.

In addition to one or more of the features described above, or as an alternative, further embodiments may include wherein pressure in the first cavity is balanced with pressure in the second cavity.

In addition to one or more of the features described above, or as an alternative, further embodiments may include wherein the solenoid is integrated into the valve housing.

According to one embodiments, an inflation device includes a valve housing, wherein the valve housing includes an inlet, an outlet and a leak vent, a first cavity, a second cavity, and outlet cavity, wherein a pilot feed line couples the first cavity to the second cavity, a valve spool, wherein the valve spool includes one or more seals, a mechanical stopper for contacting the valve spool, and a solenoid for controlling fluid flow between the first cavity and the second cavity.

In addition to one or more of the features described above, or as an alternative, further embodiments may include wherein the solenoid receives inlet pressure from the first cavity and provides outlet pressure to the second cavity.

The inflation system of claim 1, In addition to one or more of the features described above, or as an alternative, further embodiments may include wherein the pilot feed line is embedded within the valve housing.

In addition to one or more of the features described above, or as an alternative, further embodiments may include wherein the first cavity includes a first end cap and the second cavity includes a second end cap, wherein the first end cap and the second end cap include O-ring seals.

In addition to one or more of the features described above, or as an alternative, further embodiments may include wherein the second end cap includes a mechanical stopper for contacting the spool and a plug for removing fluid pressure.

In addition to one or more of the features described above, or as an alternative, further embodiments may include wherein a guide face of the valve spool in the second cavity is larger than a guide face of the valve spool in the first cavity.

In addition to one or more of the features described above, or as an alternative, further embodiments may include wherein the valve spool is positioned in a closed position, the valve spool fluidly decouples the inlet from the outlet.

In addition to one or more of the features described above, or as an alternative, further embodiments may include wherein the valve spool is positioned in an open position, the valve spool fluidly couples the inlet to the outlet and blocks the leak vent.

In addition to one or more of the features described above, or as an alternative, further embodiments may include wherein pressure in the first cavity is balanced with pressure in the second cavity.

In addition to one or more of the features described above, or as an alternative, further embodiments may include wherein the solenoid is integrated into the valve housing.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 depicts a schematic of the pneumatic valve in a closed position in accordance with one or more embodiments of the invention;

FIG. 2 depicts a schematic of the pneumatic valve in an open position in accordance with one or more embodiments of the invention;

FIG. 3 depicts a schematic of a pneumatic valve in an open position with end fittings in accordance with one or more embodiments with one or more embodiments of the invention;

FIG. 4 depicts a schematic of a modular type pneumatic valve in a closed position in accordance with one or more embodiments of the invention; and

FIG. 5 depicts a schematic of a modular type pneumatic valve in an open position in accordance with one or more embodiments of the invention.

### DETAILED DESCRIPTION

The pneumatic inflation valve and system described herein provides a design with a pressure balanced spool. In addition, one or more embodiments of the invention include a solenoid operated inflation valve having a manifold housing with multiple internal feed holes for directing the fluid flow. Embodiments of the invention also provide a design for a reusable pneumatic valve having removable end caps and plugs for resetting the valve spool and testing the seals within the valve and system.

In today's environment, traditional inflation valves are equipped with external pilot lines and solenoids that are used in the operation of the inflation valve. The external pilot lines that are located outside of the housing assembly are exposed to damage where the joints and interfaces of the device are required to have high leak tightness to ensure the reliability in the operation of the pneumatic valve. In addition, conventional inflation valves are not configured to allow for leak testing of the internal seals after the valve has been finally assembled.

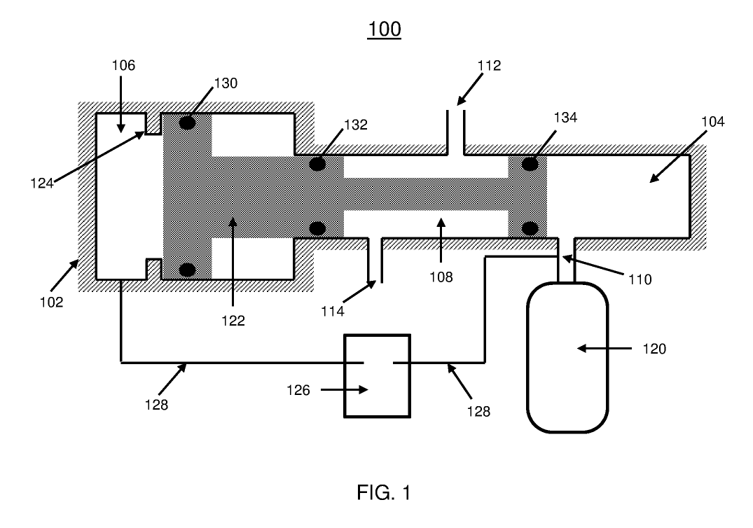

Now referring to FIG. 1, a diagram of a pneumatic valve 100 is shown in a closed position in accordance with one or more embodiments.

The pneumatic valve 100 includes a valve housing 102, wherein the valve housing 102 includes several cavities, inlets and outlets. In addition, the valve housing 102 includes the valve spool 122. In a non-limiting example, the valve 100 includes three cavities including a first cavity 104, a second cavity 106, and a third cavity 108. The valve housing 102 is also configured with an inlet 110, an outlet 112, and a leak vent 114. In one or more embodiments of the invention, the valve spool 122 includes multiple seals that contact the inner guide surfaces of the valve housing 102, such as seals 130, 132, and 134.

The first cavity 104 is located on a first section of the valve 100 having an inlet 110 to receive a fluid flow from a source 120. When the spool 122 is in the closed position, the fluid pressure from the source 120 in the first cavity 104 pushes the spool 122 in the closed position. The spool 122 is held in the closed position by a mechanical stopper 124 which makes up a portion of the valve housing 102. A solenoid 126 is coupled to the inlet 110 of the first cavity 104 and the second cavity 106 through a pilot feed line 128. As shown in FIG. 1, the pilot feed line 128 is external to the valve housing 102. In one or more embodiments of the invention, when the solenoid valve 126 is actuated the fluid pressure is provided from the gas bottle 120 and provided to the second cavity 106 through the pilot feed line 128.

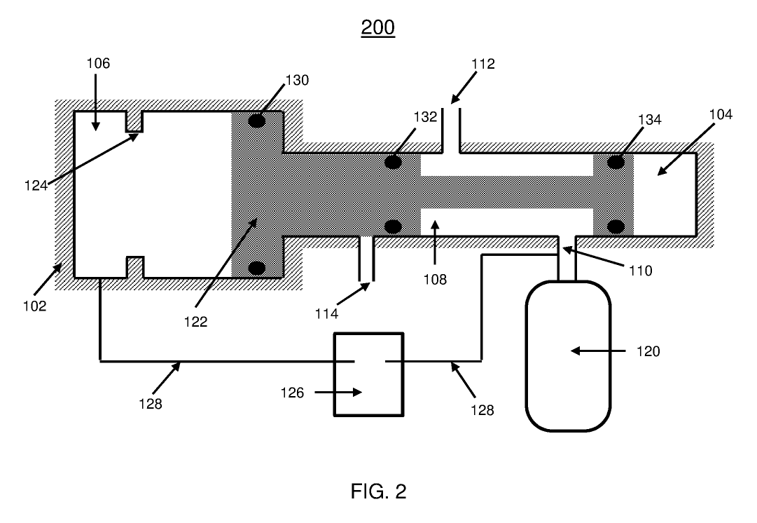

The second cavity 106 includes a mechanical stopper 124 for stopping the valve spool 122 in the housing 102. In this particular embodiment, the mechanical stopper 124 is part of the valve housing. It is to be understood that other configurations can be used for the mechanical stopper 124. The second cavity 106 is configured to receive a pilot feed line 128. In one or more embodiments of the invention, the pressure from the pilot feed line 128 forces the valve spool 122 to move to the open position as shown in FIG. 2.

The third cavity 108 includes an outlet 112 and a leak vent 114. The outlet 112 can be coupled to a device that requires inflation. When in the closed position, the leak vent 114 prevents fluid pressure from building up and be provided to the coupled inflatable device through the outlet 112 in the event any major leakages occur through seal 134. Any pressure will exit through the leak vent 114.

Now referring to FIG. 2, a diagram 200 of the pneumatic valve 100 is shown in an open position in accordance with one or more embodiments of the invention. After the solenoid 126 receives a control signal, the fluid pressure from the source 120 is provided through the pilot feed line 128 to the second cavity 106. In accordance with one or more embodiments of the invention, the cross section form of the head/guide face of the valve spool 122 in the second cavity 106 is bigger than the cross section form of the head/guide face of the valve spool 122 in the first cavity 104. This design of the valve spool 122 results in more force on the head/guide face of the valve spool 122 inside the second cavity 106 than in first cavity 104 actuating the valve spool 122 in its open position. It is to be understood that other configurations and designs are within the scope of the invention.

As shown in FIG. 2, when the valve spool 122 is in the open position the valve spool 122 rests on a portion of the valve housing 102. In the open position, the leak vent 114 is blocked by the valve spool 122. Also, the inlet 110 is provided a path through the third cavity 108 to the outlet 112 to a coupled device.

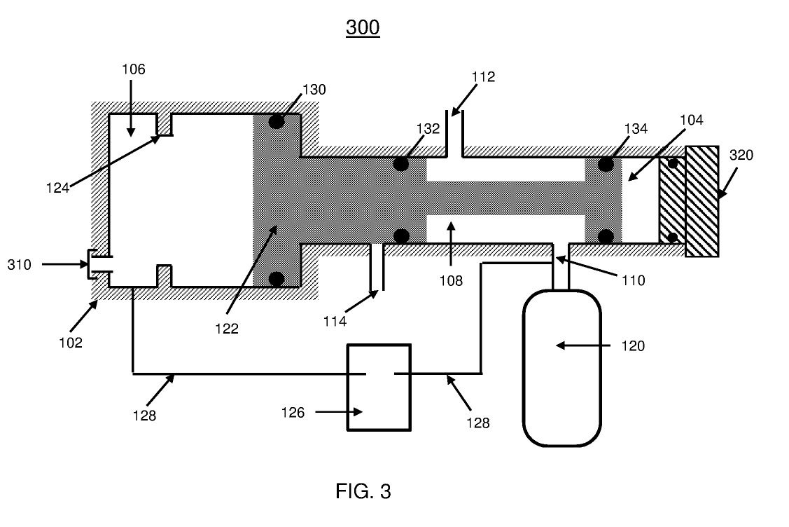

Now referring to FIG. 3, a diagram 300 of a pneumatic valve is shown in a closed position in accordance with one or more embodiments of the invention. The pneumatic valve 300 is similar to the valve 100 shown in FIG. 1. This configuration of the pneumatic valve 300 includes a first end cap 320 and second end cap 310. In one or more embodiments of the invention, when the pneumatic valve 100 is in the fully open position, the solenoid valve 126 is closed. These caps 310, 320 are used to reset the spool 122 after the valve 100 is opened. In one or more embodiments of the invention the first end cap 320 is threaded and can be screwed into the valve housing 102. Also, the first end cap 320 can use seals to ensure there are no leaks from the first cavity 104 during operation. After removing the end cap 320 the spool 122 can be manually pushed back to the closed position. The end cap 320 must only be removed after the gases from the gas bottle 120 are completed discharged. By removing the end plug/cap 310, the trapped gas in the second cavity 106 is able to escape allowing the valve spool 122 to be easily reset. It is to be understood that the position for the end caps 310 and 320 can be placed in other locations suitable to the design and also that any other type of end cap, plug, fitting, etc. can be used.

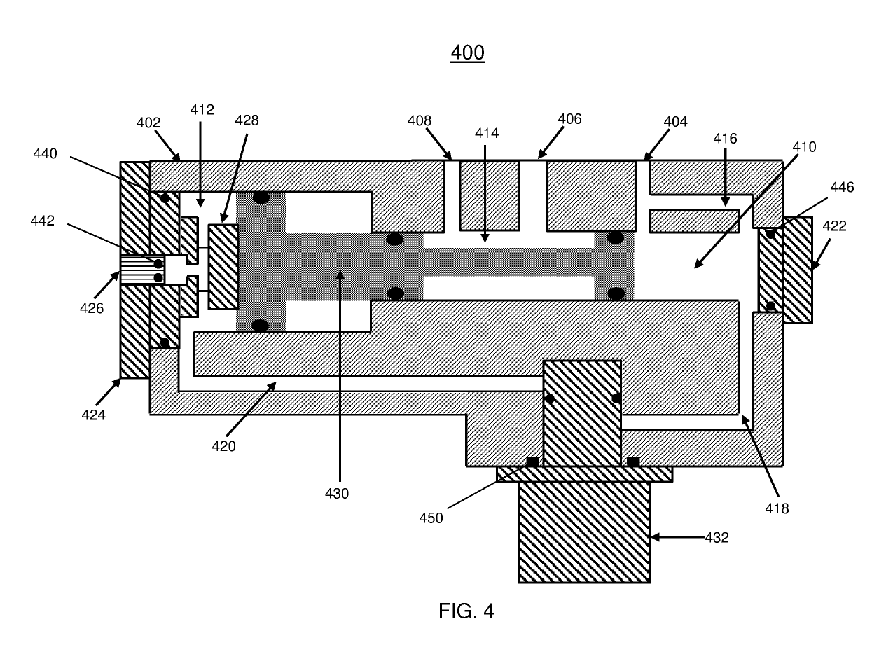

Now referring to FIG. 4, a diagram 400 of a pneumatic valve having a modular assembly in a closed position is shown in accordance with one or more embodiments. As shown in FIG. 4, the pneumatic valve body 402 is a single manifold provided with internal holes/cavities to direct the fluid flow. The pneumatic valve body 402 includes inlet 404, outlet 406, and leak vent 408. The pneumatic valve body 402 includes cavities such as a first cavity 410, second cavity 412, and output cavity 414. The pneumatic valve body 402 also includes feed lines/holes such as the feed hole 416, solenoid inlet feed hole 418 and solenoid outlet feed hole 420. The pneumatic valve body also includes end caps 422, 424, and an end plug 426. In one or more embodiments of the invention, the end cap 422 is coupled to the first cavity 410 and can be used to access the valve spool 430. The end cap 424 is coupled to the second cavity 412 where the end cap 424 includes a plug 426. The end cap 424 and/or the plug 426 can be removed to release the pressure from the second cavity 412 to easily replace/reset the valve spool 430 to the closed position. The pneumatic valve body 402 includes valve spool 430. As shown in FIG. 4, a solenoid 432 is integrated into the pneumatic valve body 402. In one or more embodiments of the invention a seal 450 is provided between the valve body 402 and the solenoid 432 to ensure that no unwanted leakages exist.

In one or more embodiments of the invention, the spool 430 can include one or more seals similar to that seals 130, 132 and 134 of FIG. 1. The seals can be O-ring seals or other types of known seals can also be used. It is to be understood that end caps 422 and 424, and end plug 426 can include O-ring seals as necessary. For example, the end cap 422 can include the seal 446, end cap 424 can include the seal 440, and the end plug can include the seal 442.

In one or more embodiments of the invention, the solenoid 432 is integrated into the valve housing 402. Also, the pilot feed holes 416, 418, 420 are integrated within the valve housing 402. In this non-limiting example, there is no requirement for an external pilot feed line to couple the first cavity 410 to the second cavity 412 as the shown in FIG. 1.

The valve 400 as shown in FIG. 4 is in the closed position. The fluid pressure source (not shown) can be connected to the inlet 404 of the valve housing 402 to provide a source of fluid pressure. The fluid pressure provided at the inlet 404 provides sufficient pressure to keep the valve spool 430 in the closed position prior to actuating solenoid 432. The valve spool 430 is stopped by the mechanical stopper 428, which is integrated into the end cap 424, positioned in the second cavity 412.

In one or more embodiments of the invention, the valve housing 402 can include a hexagonal shape where the inlets, outlets and other features, such as holes for gas bottle charging and safety plug mounting, can be located on the same or different faces.

In one or more embodiments of the invention, the interface caps are provided with threaded joints and static seals.

In one or more embodiments of the invention, if the solenoid valve seal or O-ring seal leaks in the stored condition, a small leak vent port can be provided in the second cavity to allow the leaked gas to continuously escape.

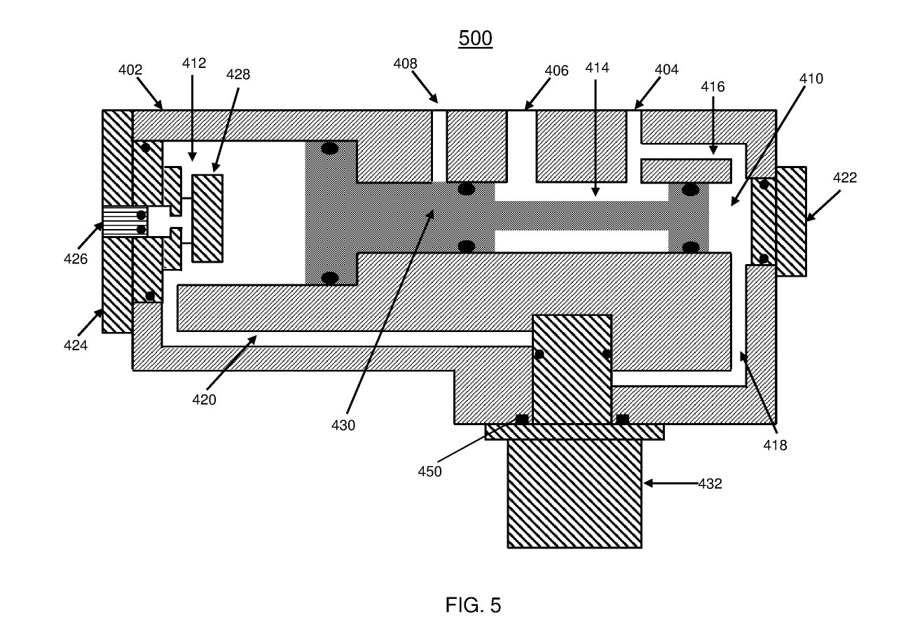

Now referring to FIG. 5, a diagram 500 of the pneumatic valve of FIG. 4 is shown in the open position in accordance with one or more embodiments of the invention. The valve 400 opens allowing fluid pressure to be directed toward a connected device to outlet 406 when the solenoid 432 is actuated. The fluid pressure from the source is provided to the feed hole 416 which routes the pressure through feed hole 418 of the solenoid 432. The solenoid 432 allows the fluid pressure to flow through feed hole 420 and into the second cavity 412. As the pressure continues to build in the second cavity 412 there will be enough force to push the spool 430 forward to the open position. The spool 430 is stopped by the housing 402. In one or more embodiments of the invention, the solenoid 432 can be de-energized after a period of time because the pressure in the second cavity will keep the valve 400 in the open position at least until the fluid source has been emptied. In one or more embodiments of the invention, the spool 430 can be held in position by a magnet or other mechanism.

This particular configuration provides a compact modular design. By incorporating the pilot feed line in the valve housing, there is no concern for an external pilot feed line being damaged prior to or during operation. Also, because the feed line, valve and solenoid connections/couplings come in various sizes, there is no longer a need to match the fitting of the pilot feed line with the valve and the solenoid. The manifold type configuration also obviates the need to ensure the fittings between the valve and the solenoid are void of any leaks because the connections are now embedded within the valve housing. The manifold configuration includes a plurality of internal feed lines/holes that are used to route the fluid flow between the various cavities of the valve. The manifold can be fitted with features for fluid filling port, safety discharge port, valve inlet and outlets, etc. In one or more embodiments of the invention, the manifold can be made of aluminum alloy or other suitable high strength, light weight material process using an additive manufacturing technique.

The interface fittings between the solenoid and the main valve body must be void of leaks for efficient operation of the valve. As the valve assembly is handled over time and is exposed to abusive loads the leak tightness between the threaded fittings of the external pilot feed line and the fittings at the assembly joints can become compromised and begin to leak.

In one or more embodiments of the invention, suitable end fittings and caps can be provided to reset the valve spool to the closed position by manual venting of the trapped gas in the actuation cavity. In addition, the seals can be leak tested in its final assembled conditions due to the removable end caps that provide access the internal seals of the valve.

By using the pressure balanced principle, the pressure used to charge one of the cavities to engage the spool is kept to a minimum. In addition, the flow port size of the pneumatic valve and the amount of force required to change the position of the spool can be kept at a minimum.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An inflation system comprising:
a fluid source;
a valve housing, wherein the valve housing includes an inlet, an outlet and a leak vent, wherein the fluid source is coupled to the inlet;
a first cavity, a second cavity, and outlet cavity, wherein a pilot feed line couples the first cavity to the second cavity;
a valve spool positioned within the valve housing, wherein the valve spool includes one or more seals; and
a solenoid for controlling fluid flow between the first cavity and the second cavity.

2. The inflation system of claim 1, wherein the solenoid receives inlet pressure from the first cavity and provides outlet pressure to the second cavity.

3. The inflation system of claim 1, wherein the pilot feed line is embedded within the valve housing.

4. The inflation system of claim 1, wherein the first cavity includes a first end cap and the second cavity includes a second end cap, wherein the first end cap and the second end cap include O-ring seals.

5. The inflation system of claim 4, wherein the second end cap includes a mechanical stopper for contacting the spool and a plug for removing fluid pressure.

6. The inflation system of claim 1, wherein a guide face of the valve spool in the second cavity is larger than a guide face of the valve spool in the first cavity.

7. The inflation system of claim 1, wherein the valve spool is positioned in a closed position, the valve spool fluidly decouples the inlet from the outlet.

8. The inflation system of claim 1, wherein the valve spool is positioned in an open position, the valve spool fluidly couples the inlet to the outlet and blocks the leak vent.

9. The inflation system of claim 1, wherein pressure in the first cavity is balanced with pressure in the second cavity.

10. The inflation system of claim 1, wherein the solenoid is integrated into the valve housing.

11. An inflation device comprising:
a valve housing, wherein the valve housing includes an inlet, an outlet and a leak vent;
a first cavity, a second cavity, and outlet cavity, wherein a pilot feed line couples the first cavity to the second cavity;
a valve spool, wherein the valve spool includes one or more seals;
a mechanical stopper for contacting the valve spool; and
a solenoid for controlling fluid flow between the first cavity and the second cavity.

12. The inflation device of claim 11, wherein the solenoid receives inlet pressure from the first cavity and provides outlet pressure to the second cavity.

13. The inflation device of claim 11, wherein the pilot feed line is embedded within the valve housing.

14. The inflation device of claim 11, wherein the first cavity includes a first end cap and the second cavity includes a second end cap, wherein the first end cap and the second end cap include O-ring seals.

15. The inflation device of claim 14, wherein the second end cap includes the mechanical stopper for contacting the spool and a plug for removing fluid pressure.

16. The inflation device of claim 11, wherein a guide face of the valve spool in the second cavity is larger than a guide face of the valve spool in the first cavity.

17. The inflation device of claim 11, wherein the valve spool is positioned in a closed position, the valve spool fluidly decouples the inlet from the outlet.

18. The inflation device of claim 11, wherein the valve spool is positioned in an open position, the valve spool fluidly couples the inlet to the outlet and blocks the leak vent.

19. The inflation device of claim 11, wherein pressure in the first cavity is balanced with pressure in the second cavity.

20. The inflation device of claim 11, wherein the solenoid is integrated into the valve housing.
